(19) United States
(12) Patent Application Publication
(10) Pub. No.: US 2020/0273371 A1
(43) Pub. Date: Aug. 27, 2020

(54) APPARATUS FOR AIDING THE VISUALLY IMPAIRED

(71) Applicants: Julie Berchtold, Los Angeles, CA (US); Samantha Harris, Los Angeles, CA (US)

(72) Inventors: Julie Berchtold, Los Angeles, CA (US); Samantha Harris, Los Angeles, CA (US)

(21) Appl. No.: 16/286,375

(22) Filed: Feb. 26, 2019

(51) Int. Cl. G09B 21/00; G09F 3/02; G09F 3/08

(52) U.S. Cl. CPC G09B 21/008; G09F 3/02; G09F 2003/0273; G09F 2003/0251; G09F 3/08

(57) ABSTRACT

A device for aiding the visually impaired is presented. The device comprises a sleeve configured to fit around and removably couple onto the body of a toiletry container. The outside body of the sleeve includes a visual text area comprising a dominant letter that could be easily read in a bathroom environment a by person that is visually impaired. The text in the visual text area indicates the type of toiletry. The sleeve also includes a descriptive text area on the outside body comprising a description of said toiletry.

### BACKGROUND OF THE INVENTION

### Field of the Invention

Embodiments of the invention relates to the field of visual enhancement. More specifically, the invention relates to an apparatus for aiding the visually impaired in a bathroom type environment.

### Description of the Related Art

There are many naturally occurring things that happen to humans during the aging process. One of the most common and inevitable of these is losing the focusing ability for near vision. This “aging eye condition” is called Presbyopia and can begin affecting adults as early as age 35. By age 45, an estimated 83% of adults in North America will experience this visual impairment.

This phenomenon makes one to have to hold books or labels further away to be able to read them without causing strain on the eyes. This happens due to a gradual loss of flexibility in the lenses of the eye, which allows a change in focus from objects that are far away to objects that are close. Of course, there is only so far that one can hold an object in attempt to read it, which can become particularly challenging in situations where reading glasses may not be readily available. The result of this can be a frustrating inability to perform once-effortless tasks, such as picking up the correct bottle while in the shower.

The current problem is that containers for toiletries, such as soap, shampoo, conditioner, etc. have identifying text that is hard to read for those that are visually impaired especially in the bathroom environment where one usually would not wear their visual aid, e.g. glasses. In addition, environments like a shower have significantly less lighting than the rest of the bathroom therefore increasing the difficulty in identifying the proper type of toiletry. Thus, oftentimes the user would have to squint to make sure they are applying the correct product for the task. In some instance, the user misreads the product.

Also, these toiletries sometimes come in different container configurations and colors resulting in a chaotic looking bathroom environment.

To overcome the problems and limitations described above, there is a need for an apparatus to aid the visually impaired to readily identify toiletries in bathroom type environment.

### BRIEF SUMMARY OF THE INVENTION

One or more embodiments of the invention are directed to an apparatus for aiding the visually impaired in a bathroom type environment. The invention comprises a stylized solution to the eye-straining struggle of reading labels while bathing. The body of the device comprises a stretchable material, e.g. neoprene-based or terry cloth. The material is preferably durable, washable, and configurable to slip over most showering products. The body further comprises large lettering for easy discernment without requiring the aid of optical correcting lenses.

The large lettering is easily distinguishable, marked with a single letter for the corresponding product, e.g. “S” for Shampoo, “C” for Conditioner, “W” for body wash, and “F” for Facewash.

In one or more embodiments, the device comprises a sleeve with a visual text illustration area and a descriptive text illustration area. The sleeve comprises a body made of resilient and/or waterproof type material configured to fit around the body of a toiletry, e.g. a shampoo bottle. For instance, the body material may be such that it is capable of stretching over containers of different sizes and shapes.

One or more embodiments of the present invention comprises a sleeve with a body configured as a sheet of resilient material that wraps around the toiletry container with a fastener to removably and snugly couple the sleeve onto the toiletry container.

One or more embodiments of the present invention further comprises one or more visual text area wherein one or more dominant letters indicating the type of toiletry is placed. For instance, if the toiletry is a shampoo, then the letter may be a large “S” that is significantly dominant on the outer body; if the toiletry is a conditioner, then the letter may be a large “C” that is significantly dominant on the outer body; if the toiletry is a moisturizer, then the letter may be a large “M” that is significantly dominant on the outer body; if the toiletry is a body wash, then the letter may be a large “W” that is significantly dominant on the outer body. The dominance of the text should be such that it is easily readable by a person that is visually impaired. The visual impairment may be due to inadequate lighting and/or deteriorating sight, for example.

One or more embodiments of the present invention further comprises one or more descriptive text area for providing a description of the product. The descriptive text area is configured for providing textual description of the product that conforms to the dominant letter indication of the product. For instance, if the dominant letter in the visual text area is an “S”, then the description in the descriptive text area may be “shampoo”; if the dominant letter in the visual text area is a “C”, then the description in descriptive text area may be “conditioner”; if the dominant letter in the visual text area is an “M”, then the description in descriptive text area may be “moisturizer”; if the dominant letter in the visual text area is a “W”, then the description in descriptive text area may be “body wash”; etc.

### BRIEF DESCRIPTION OF THE DRAWINGS

The above and other aspects, features and advantages of the invention will be more apparent from the following more particular description thereof, presented in conjunction with the following drawings wherein:

FIG. 1 is an illustration of a sleeve in accordance with one or more embodiments of the present invention.

FIG. 2A is an exemplary illustration of a shampoo bottle with the sleeve of an embodiment of the present invention configured for a shampoo bottle.

FIG. 2B is an exemplary illustration of a conditioner bottle with the sleeve of an embodiment of the present invention configured for a conditioner bottle.

FIG. 3 is an exemplary illustration of a plurality of bottles with each configured with a sleeve in accordance with one or more embodiments of the present invention.

FIG. 4A is an illustration of a sleeve configured as from a sheet body in accordance with one or more embodiments of the present invention.

FIG. 4B is an illustration of the sheet body of FIG. 4A in an unfolded configuration in accordance with one or more embodiments of the present invention.

### DETAILED DESCRIPTION

The present invention comprising an apparatus for aiding the visually impaired will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

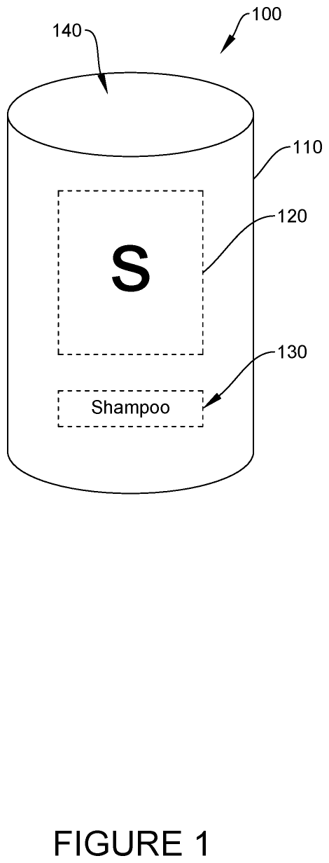

One or more embodiments of the present invention will now be described with references to FIGS. 1-4.

FIG. 1 is an illustration of the sleeve 100 in accordance with one or more embodiments of the present invention. As illustrated, sleeve 100 comprises a body 110, an orifice 140; a visual text illustration area 120 and a descriptive text illustration area 130. In one or more embodiment, body 110 comprises resilient material configured to fit around the body of a toiletry, e.g. a shampoo bottle. For instance, the body material may such that it is capable of stretching over containers of different sizes and shapes. In one or more embodiments, orifice 140 is configured to snugly fit around the body of the toiletry container.

In one or more embodiments, body 110 comprises a waterproof type material, rubber, plastic, etc.

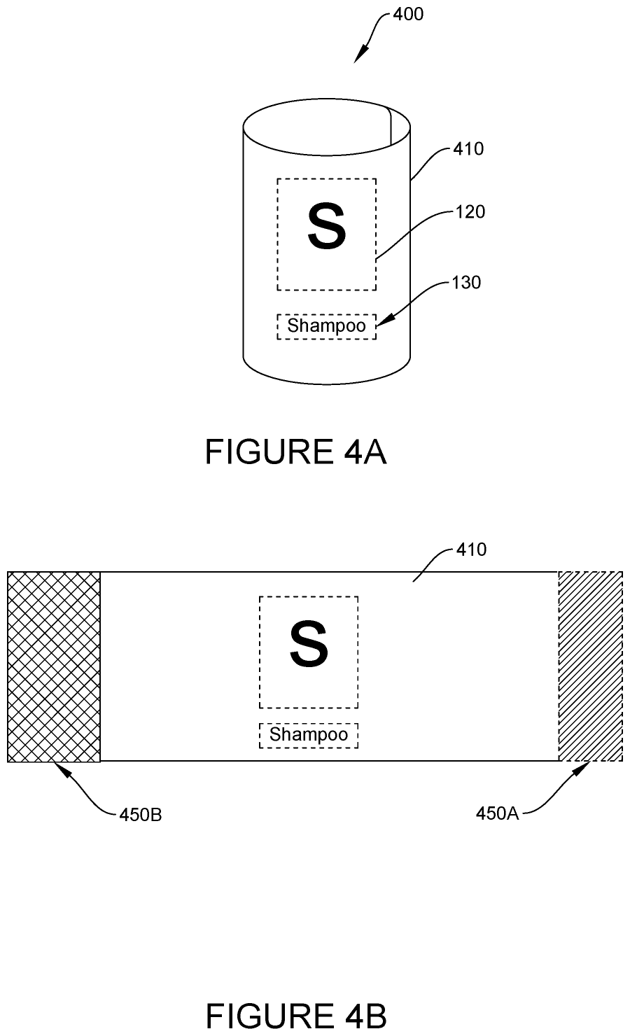

In other embodiments, the sleeve may be configured as a sheet of resilient material that wraps around the toiletry container with a fastener to removably and snugly couple the sleeve onto the toiletry container, as illustrated in FIGS. 4A-4B. As illustrated, sleeve 400 comprises a sheet body 410, a visual text illustration area 120 and a descriptive text illustration area 130.

In one or more embodiments, the fastener may comprise a hook-and-loop type fastener, with the hook component on one end of the sheet and the loop component on the other end of the sheet. For instance, the hook component, e.g. 450A, of the hook-and-loop fastener may be located at a first end and on the back side of the sheet body 410; and the loop component, e.g. 450B, of the hook-and-loop fastener may be located at a second end and on the front side of the sheet body 410. The loop component may cover a wider area than the hook component to provide for flexibility in coupling to containers of different sizes and shapes. Those of skill in the art would appreciate that other types of fasteners, e.g. glue, are contemplated.

One or more embodiments of the present invention further comprises one or more visual text area 120 wherein one or more dominant letters indicating the type of toiletry is placed. For instance, if the toiletry is a shampoo, then the letter may be a large “S” that is significantly dominant on the outer body; if the toiletry is a conditioner, then the letter may be a large “C” that is significantly dominant on the outer body; if the toiletry is a moisturizer, then the letter may be a large “M” that is significantly dominant on the outer body; if the toiletry is a body wash, then the letter may be a large “W” that is significantly dominant on the outer body. The dominance of the text should be such that it is easily readable by a person that is visually impaired. Those of skill in the art would appreciate that these illustrations are examples and that other configurations are contemplated. For instance, some embodiments may include two or more letters, e.g. “BW” for body wash and “FW” for face wash. In one or more embodiments, the size of the letter or letters in the visual text area 120 may be equal to or at least about: 20, 30, 40, 50, 60, 70, 75, 80, 85, 90, 95, 100, 105, 110, 115, 120, 125, 130, 135, 140, 145, 150, 155, 160, 165, 170, 175, 180, 185, 190, 195, 200 points or ranges including and/or spanning the aforementioned values. Those of skill in the art would appreciate that the fonts sizes specified herein are for illustrative only and that the invention should not be construed to be limited to these values.

One or more embodiments of the present invention further comprises one or more descriptive text area 130 for providing a description of the product. As illustrated, area 130 is configured for providing textual description of the product that conforms to the dominant letter indication of the product, i.e. 120. For instance, if the dominant letter in area 120 is an “S”, then the description in area 130 may be “shampoo”; if the dominant letter in area 120 is a “C”, then the description in area 130 may be “conditioner”; if the dominant letter in area 120 is an “M”, then the description in area 130 may be “moisturizer”; if the dominant letter in area 120 is a “W”, then the description in area 130 may be “body wash”; etc. Those of skill in the art would appreciate that these illustrations are examples and that other combinations of dominant letter 120 and description 130 combination are contemplated. In one or more embodiments, the font size of the descriptive text 130 is much less than the font size of the dominant text 120, as illustrated in the figures. For instance, the font size in descriptive text area 130 may be equal to or at least about: 10, 12, 14, 16, 18, 20, 22, 24, 28, 30 points or ranges including and/or spanning the aforementioned values. Those of skill in the art would appreciate that the fonts sizes specified herein are for illustrative purposes only and that the invention should not be construed to be limited to these values.

In one or more embodiments, the font size of the dominant text is scaled to a value that is multiple times the font size of the descriptive text. For instance, the ratio of the font size in dominant text area 120 to the font size in the descriptive text area 130 may be equal to or at least about: 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1 or ranges including and/or spanning the aforementioned values.

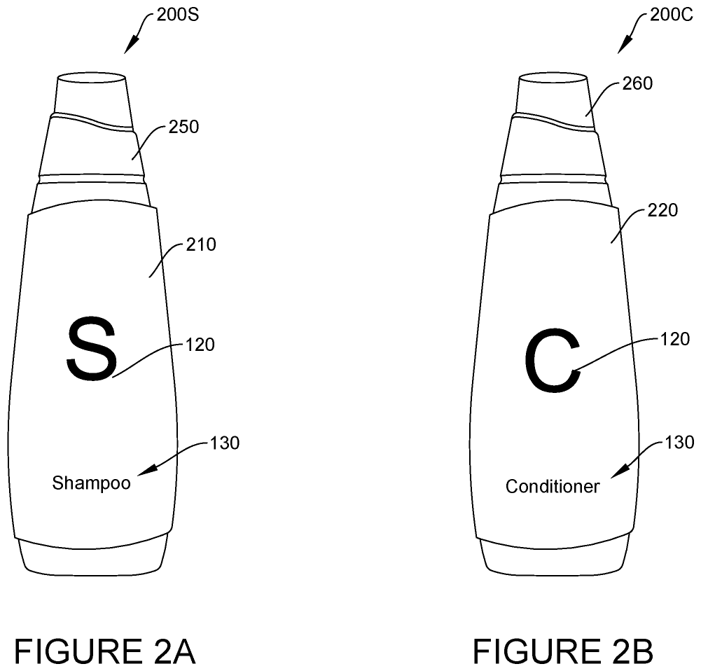

FIG. 2A is an exemplary illustration 200S of a shampoo bottle with the sleeve of an embodiment of the present invention configured for a shampoo bottle. As illustrated, sleeve 210 is configured for a shampoo bottle and it is removably coupled onto shampoo bottle 250. The dominant visual text area 120 comprises the letter “S” and the descriptive text area 130 comprises the text “shampoo”.

FIG. 2B is an exemplary illustration 200C of a conditioner bottle with the sleeve of an embodiment of the present invention configured for a conditioner bottle. As illustrated, sleeve 220 is configured for a conditioner bottle and it is removably coupled onto conditioner bottle 260. The dominant visual text area 120 comprises the letter “C” and the descriptive text area 130 comprises the text “conditioner”.

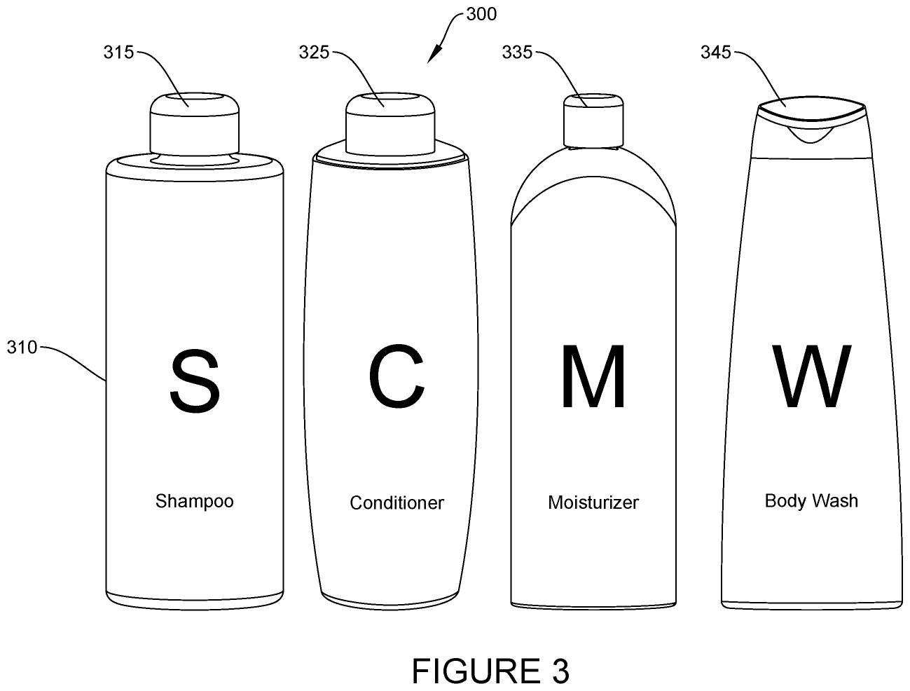

FIG. 3 is an exemplary illustration 300 of a plurality of bottles with each configured with a sleeve in accordance with one or more embodiments of the present invention. This illustration provides a visualization of how the sleeves (e.g. 310, 320, 330, and 340) of embodiments of the present invention makes multiple different toiletry containers (e.g. 315, 325, 335, and 345) look aesthetically pleasing.

In the embodiments described herein, the sleeve 100 is preferably reusable. However, nothing in this disclosure prevents the sleeve from being made of a single use material.

While the invention herein disclosed has been described by means of specific embodiments and applications thereof, numerous modifications and variations could be made thereto by those skilled in the art without departing from the scope of the invention set forth in the claims.

What is claimed is:

1. An apparatus for aiding the visually impaired comprising:
a body configured to fit around and removably couple onto a container of a toiletry;
a visual text area on said body comprising a dominant letter indicating the toiletry; and
a descriptive text area on said body comprising a description of said toiletry.

2. The apparatus of claim 1, wherein said body is configured as a sleeve.

3. The apparatus of claim 1, wherein said body comprises resilient material.

4. The apparatus of claim 1, wherein said body comprises a sheet of material with a fastener for removably coupling onto said container.

5. The apparatus of claim 1, wherein said body comprises waterproof material.
